(19) United States
(12) Patent Application Publication
(10) Pub. No.: US 2015/0034858 A1
(43) Pub. Date: Feb. 5, 2015

(54) THERMALLY CONDUCTIVE POLYMER COMPOSITIONS TO REDUCE MOLDING CYCLE TIME

(71) Applicants: Chandrashekar Raman, Sheffield Village, OH (US); Wayne A. Earley, Westerville, OH (US)

(72) Inventors: Chandrashekar Raman, Sheffield Village, OH (US); Wayne A. Earley, Westerville, OH (US)

(21) Appl. No.: 14/516,600

(22) Filed: Oct. 17, 2014

Related U.S. Application Data
(63) Continuation of application No. PCT/US2013/036940, filed on Apr. 17, 2013.
(60) Provisional application No. 61/625,289, filed on Apr. 17, 2012.

(51) Int. Cl. C09K 5/14; B29C 45/00; C08J 5/00

(52) U.S. Cl. CPC C09K 5/14; C08J 5/00; B29C 45/0013; C08J 2300/24; B29K 2101/10
USPC 252/74; 252/73; 252/79; 252/77; 252/78.1; 264/328.1; 264/328.2

(57) ABSTRACT

A thermally conductive polymer composition comprising (1) a polymer material, and (2) a thermally conductive filler. The thermally conductive filler can be boron nitride. The thermally conductive polymer composition can be used in a molding operation to form a molded article and can reduce the molding cycle time of a molding process. In one embodiment, increasing the thermal conductivity of a polymer material (as compared to the thermal conductivity of the material in the absence of a thermally conductive filler) increases the thermal diffusivity and reduces the cooling time of the article. The present invention also provides methods of forming molded articles from such compositions.

### REFERENCE TO RELATED APPLICATIONS

This application is a continuation of International Patent Application No.: PCT/US2013/036940, entitled “Thermally Conductive Polymer Compositions to Reduce Molding Cycle Time,” filed on Apr. 17, 2013, which claims the priority benefit of U.S. Provisional Patent Application No.: 61/625,289, entitled “Thermally Conductive Polymer Compositions to Reduce Molding Cycle Time,” filed on Apr. 17, 2012, each of which are hereby incorporated in their entirety by reference.

### FIELD

The present application relates to thermally conductive polymer compositions for use in molding operations and methods of molding employing such compositions.

### BACKGROUND

The process of forming an article by molding comprises filling a mold that defines a cavity having a selected shape with a suitable material and letting the material set in the mold to form and retain the final shape of the article. The nature of how the material sets will depend on the material being employed. For thermoplastics, setting is accomplished by the cooling or freezing of the material. For thermosets, the setting involves curing or crosslinking of the material.

For practical implementation, a molding process to form an article generally comprises: (1) an optional pre-loading step comprising charging an initial quantity of a polymer, or polymer composite, material in a mold; (2) closing the two halves of the mold to define a cavity having a desired shape; (3) metering a polymer material to the cavity in the mold; (4) holding the mold under pressure while the material disposed in the mold cavity cools or crosslinks to form the desired molded product/part; and (5) opening the mold and removing/ejecting the article(s) from the mold.

The sequence described above may be referred to as a molding cycle. The above cycle is fairly generic and applies to both thermoplastic and thermoset resins. For thermoplastic materials, a modified version of this cycle, referred to as injection molding, is employed for high throughput processing. In injection molding of plastic materials, the pre-loading step is often skipped and the thermoplastic melt is metered into the mold using a single screw injection screw.

Reducing the time for conducting a molding cycle (the “cycle time”) is one of the most effective ways of reducing the cost of manufacturing the final article. The cycle time is, however, limited by the time required for the material to heat to the required temperature and freeze/crosslink in the mold and assume the final required shape.

The time taken by the article to heat and cool is directly related to the thermal conductivity, or more specifically the thermal diffusivity, of the material in mold. The thermal conductivity and thermal diffusivity are related by the equation: α=k/ρCρ, where a is the thermal diffusivity, k is the thermal conductivity, ρ is the density and Cp is the specific heat capacity of the material. The thermal diffusivity is the best measure of the rate at which heat is dissipated in a material.

### SUMMARY

The present invention provides thermally conductive polymer compositions. In one aspect, the present invention provides a thermally conductive polymer composition. In one embodiment, the thermally conductive polymer composition comprises (1) a polymer material, and (2) a thermally conductive filler. In one embodiment, the thermally conductive filler comprises boron nitride.

The thermally conductive polymer composition is suitable for use in a molding operation to form a molded article. The inventors have found that a thermally conductive polymer composition comprising a thermally conductive filler reduces the molding cycle time of a molding process. In one embodiment, increasing the thermal conductivity of a polymer material (as compared to the thermal conductivity of the material in the absence of a thermally conductive filler) increases the thermal diffusivity and reduces the cooling time of the article.

In one embodiment, the present invention provides a method for forming a molded article comprising (a) metering a polymer composition to a mold defining a cavity, (b) holding the mold under pressure for a period of time and allowing the polymer composition to cool and/or cross-link to form a molded article, and, (c) removing the molded article from the mold, wherein the polymer composition comprises a (i) polymer material, and a (ii) a thermally conductive filler.

In one embodiment, the polymer composition comprises the thermally conductive filler in an amount of from about 0.1 percent by weight to about 70 percent by weight of the polymer composition. In one embodiment, the polymer composition comprises the thermally conductive filler in an amount of from about 1 percent by weight to about 30 percent by weight of the polymer composition. In one embodiment, the polymer composition comprises the thermally conductive filler in an amount of from about 1.5 percent by weight to about 10 percent by weight of the polymer composition. In one embodiment, the polymer composition comprises the polymer composition comprises the thermally conductive filler in an amount of from about 2 percent by weight to about 5 percent by weight of the polymer composition.

In one embodiment, the thermally conductive filler is chosen from a metal oxide, a metal boride, a metal carbide, a metal nitride, a metal silicide, carbon black, graphite, expanded graphite, carbon fiber, or graphite fiber or a combination of two or more thereof; alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, expanded graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, boron nitride nanosheets, zinc oxide nanotubes, etc., and mixtures of two or more thereof.

In one embodiment, the thermally conductive filler is a white filler. According to one embodiment, the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, nano-scale fillers such as boron nitride nanotubes, boron nitride nanosheets, zinc oxide nanotubes, and mixtures of two or more thereof.

In one embodiment, the white filler has a specific surface area of 0.01 m²g⁻¹ to 300 m²g⁻¹. In one embodiment, the white filler has a specific surface area of 0.1 m²g⁻¹ to 100 m²g⁻¹.

In one embodiment, the thermally conductive filler comprises boron nitride. According to one embodiment, the polymer composition comprises boron nitride in an amount of from about 3 percent by weight to about 10 percent by weight of the polymer composition.

In one embodiment, the polymer material is chosen from a thermoplastic or thermoset material. According to one embodiment, the polymer material is chosen from polycarbonate, a polyolefin, an acrylic, a vinyl, a fluorocarbon, a polyamide, a polyester, a polyphenylene sulfide, a liquid crystal polymer, an epoxy, a polyimide, a polyester, an acrylonitrile, or a combination of two or more thereof.

In one embodiment, the mold is formed from a polymer composition comprising (iii) a polymer material, and (iv) a thermally conductive filler.

According to one embodiment, the polymer material (iii) is a thermoset material.

In one embodiment, the thermally conductive material (iv) comprises boron nitride.

According to one embodiment, the time for performing steps (a)-(c) is less than the time for performing such steps using a polymer composition that is devoid of the thermally conductive filler (ii).

In another aspect, the present invention provides, a method for forming a molded article comprising: (a) metering a polymer composition to a mold defining a cavity; (b) holding the mold under pressure for a period of time and allowing the polymer composition to cool and/or cross-link to form a molded article; and (c) removing the molded article from the mold, wherein the mold is formed from a polymer composition comprises a (i) polymer material, and a (ii) a thermally conductive filler.

In one embodiment, the polymer composition comprises the thermally conductive filler in an amount of from about 0.1 percent by weight to about 70 percent by weight of the polymer composition; from about 1 percent by weight to about 30 percent by weight of the polymer composition; from about 1.5 percent by weight to about 10 percent by weight of the polymer composition; even from about 2 percent by weight to about 5 percent by weight of the polymer composition.

In one embodiment, the thermally conductive filler is chosen from a metal oxide, a metal boride, a metal carbide, a metal nitride, a metal silicide, carbon black, graphite, expanded graphite, carbon fiber, or graphite fiber or a combination of two or more thereof; alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, expanded graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, boron nitride nanosheets, zinc oxide nanotubes, etc., and mixtures of two or more thereof.

In one embodiment, the thermally conductive filler is a white filler. According to one embodiment, the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, nano-scale fillers such as boron nitride nanotubes, boron nitride nanosheets, zinc oxide nanotubes, and mixtures of two or more thereof.

In one embodiment, the white filler has a specific surface area of 0.01 m²g⁻¹ to 300 m²g⁻¹. In one embodiment, the white filler has a specific surface area of or 0.1 m²g⁻¹ to 100 m²g⁻¹.

According to one embodiment, the thermally conductive filler comprises boron nitride.

In one embodiment, the polymer composition comprises boron nitride in an amount of from about 3 percent by weight to about 10 percent by weight of the polymer composition.

In one embodiment, the polymer material is chosen from a thermoplastic or thermoset material.

According to one embodiment, the polymer material is chosen from polycarbonate, polyolefins (e.g., polyethylene, polypropylene, etc.) acrylics, vinyls, fluorocarbons, polyamides, polyesters, polyphenylene sulfide, and liquid crystal polymers, an epoxy, a polyimide, a polyester, an acrylonitrile, or a combination of two or more thereof.

In one embodiment, a molded article is formed by any of the methods described above.

According to one embodiment, a thermally conductive composition comprising: a polymer material; and a thermally conductive filler.

In one embodiment, the polymer composition comprises the thermally conductive filler in an amount of from about 0.1 percent by weight to about 70 percent by weight of the polymer composition; from about 1 percent by weight to about 30 percent by weight of the polymer composition; from about 1.5 percent by weight to about 10 percent by weight of the polymer composition; even from about 2 percent by weight to about 5 percent by weight of the polymer composition.

According to one embodiment, the thermally conductive filler is chosen from a metal oxide, a metal boride, a metal carbide, a metal nitride, a metal silicide, carbon black, graphite, expanded graphite, carbon fiber, or graphite fiber or a combination of two or more thereof; alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, expanded graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, boron nitride nanosheets, zinc oxide nanotubes, etc., and mixtures of two or more thereof.

In one embodiment, the thermally conductive filler is a white filler. According to one embodiment, the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, nano-scale fillers such as boron nitride nanotubes, boron nitride nanosheets, zinc oxide nanotubes, and mixtures of two or more thereof.

In one embodiment, the white filler has a specific surface area of 0.01 m²g⁻¹ to 300 m²g⁻¹; or 0.1 m²g⁻¹ to 100 m²g⁻¹.

According to one embodiment, the thermally conductive filler comprises boron nitride.

In one embodiment, the polymer composition comprises boron nitride in an amount of from about 3 percent by weight to about 10 percent by weight of the polymer composition.

According to one embodiment, the polymer material is chosen from a thermoplastic or thermoset material.

In one embodiment, the polymer material is chosen from polycarbonate, a polyolefin, an acrylic, a vinyl, a fluorocarbon, a polyamide, a polyester, a polyphenylene sulfide, a liquid crystal polymer, an epoxy, a polyimide, a polyester, an acrylonitrile, or a combination of two or more thereof.

These and other aspects are further understood with reference to the following detailed description.

### DETAILED DESCRIPTION

Reference will now be made in detail to embodiments of the invention. It is to be understood that other embodiments may be utilized and structural and functional changes may be made without departing from the respective scope of the invention.

The present invention provides thermally conductive polymer compositions. In one embodiment a polymer composition comprises (1) a polymer material and (2) a thermally conductive filler.

The polymer material is not particularly limited and may be chosen from any polymer material suitable for use in a molding operation. As used herein, the term “polymer material” may include one or more of plastics, polymers, and resins. The polymer material may be selected from any material as desired for a particular purpose or intended use. Non-limiting examples of suitable polymer materials, include polycarbonate, polyolefins (e.g., polyethylene, polypropylene, etc.), acrylics, vinyls, fluorocarbons, polyamides, polyesters, polyphenylene sulfide, and liquid crystal polymers (such as thermoplastic aromatic polyesters), etc. In one embodiment, the polymer is chosen from a thermoplastic or a thermoset material. Examples of suitable thermoplastics include, but are not limited to polypropylene, polyamide, polyester, polyurethane, polyethylene or polyether ether ketone. In one embodiment, the thermoplastic polymer is a thermoplastic fluoropolymer. Non-limiting examples of suitable fluoropolymers include fluorinated ethylene propylene (FEP), copolymer of tetrafluoroethylene and perfluoro(propylvinyl ether) (PFA), homopolymers of polychlorotrifluoroethylene (PTFE) and its copolymers with TFE or difluoroethylene (VF2), ethylenechlorotrifluoroethylene (ECTFE) copolymer and its modifications, ethylene-tetrafluoroethylene (ETFE) copolymer and its modifications, polyvinylidene fluoride (PVDF), and polyvinylfluoride (PVF).

Non-limiting examples of suitable thermosetting polymers include elastomers, epoxies, polyimides, polyesters, and acrylonitriles. Suitable elastomers include, for example, styrene-butadiene copolymer, polychloroprene, nitrile rubber, butyl rubber, polysulfide rubber, ethylene-propylene terpolymers, polysiloxanes (silicones), polyurethanes, etc.

The thermally conductive polymer compositions further comprise a thermally conductive filler. While polymer materials such as plastics/polymers/resins are inherently poor conductors of heat, adding thermally conductive fillers increases the thermal conductivity of the polymer composition. The addition of a thermally conductive filler to a polymeric material has been found to increase the thermal conductivity of a polymer composition sufficiently to decrease the time required by the polymer composition to cool or crosslink in the mold, which then reduces the molding cycle time and the overall injection molding time.

As referred to herein, a “thermally conductive filler” is a material which is operable to increase the thermal conductivity of the polymer composition. The thermally conductive filler may also improve one or more other properties of the composition. Such properties include one or more chemical or physical properties relating to the formulation, function or utility of the composition, such as physical characteristics, performance characteristics, applicability to specific end-use devices or environments, ease of manufacturing the composition, and ease of processing the composition after its manufacture. In addition to enhancing the thermal conductivity of the polymer composition to which it is added, the fillers useful herein may provide other characteristics including improving reinforcing properties, lubricating properties, electrical conductivity, acting as an electrical insulator, acting as a physical extender, etc. Suitable fillers include both organic and inorganic fillers such as, for example, barium sulfate, zinc sulfide, carbon black, silica, titanium dioxide, boron nitride, clay, talc, fiber glass, fumed silica and discontinuous fibers such as mineral fibers, wood cellulose fibers, carbon fiber, boron fiber, aramid fiber, etc., and mixtures of two or more thereof.

In one embodiment, where there are no constraints on the color or electrical conductivity of the polymer composition, inexpensive fillers such as, but not limited to, powder fillers, metal powders and carbon forms such as carbon black and graphite may be added to the resin matrix to increase the thermal conductivity and reduce the cycle time of the polymer composition. Some examples of powder fillers may include, but are not limited to, carbon black powder, glass bead, polyimide powder, MoS₂ powder, steel powder, brass powder, and aluminum powder. Some examples of carbon black fillers include, but are not limited to, SAF black, HAF black, SRP black, ISAF and Austin black. Some examples of such carbon blacks, include, but are not limited to, the blacks of the series 100, 200 or 300 (ASTM grades), for example the blacks N115, N134, N234, N339, N347 and N375. However, the above additives may also make the final composition electrically conductive.

In another embodiment, it may be desired that the final polymer composition is electrically insulating rather than electrically conductive. Non-limiting examples of applications where it may be desirable for the article to be electrically insulating include the housings of electrical components, electrical connectors, and other electronic devices such as capacitors, transistors, and resistors. Achieving the same goal of reduced cycle for polymer compositions employed in producing parts for these applications requires providing polymer compositions that are thermally conductive but electrically insulating polymer compositions. Suitable fillers for such applications include, for example, ceramics or mineral fillers. Ceramic means a compound of metallic and nonmetallic elements, for which the interatomic bonding is predominantly non-ionic.

Other suitable ceramic fillers which may be used in the invention include, but are not limited to, metal oxides, borides, carbides, nitrides, silicides, carbon black, graphite, carbon fiber, or graphite fiber and mixtures or combinations thereof, and may be relatively pure or contain one or more impurities or additional phases, including composites of these materials. The metal oxides include, for example, alumina, magnesia, ceria, hafnia, lanthanum oxide, neodymium oxide, samaria, praseodymium oxide, thoria, urania, yttria, zinc oxide, zirconia, and mixtures of two or more thereof. In addition, a large number of binary, ternary, and higher order compounds such as magnesium-aluminate spinel, silicon aluminum oxynitride, borosilicate glasses, barium titanate, and mixtures of two or more thereof are useful as refractory fillers. Additional ceramic filler materials may include, for example, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, and mixtures of two or more thereof and such materials as Si—C—O—N compounds, including composites of these materials and mixtures of two or more thereof. The ceramic fillers may be in any of a number of forms, shapes or sizes depending largely on the matrix material, the geometry of the composite product, and the desired properties sought for the end product, and most typically are in the form of whiskers and fibers. The fibers can be discontinuous (in chopped form as staple) or in the form of a single continuous filament or as continuous multifilament tows. They also can be in the form of two- or three-dimensional woven continuous fiber mats or structures. Further, the ceramic mass may be homogeneous or heterogeneous.

Other suitable, but non-limiting, examples of mineral fillers include barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, expanded graphite, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, and mixtures thereof.

In another embodiment, such as consumer-related applications, there may be strict color requirements for aesthetics and/or for purposes of branding, etc. In such applications, metal powder and carbon forms may not be suitable as fillers for the polymer composition, instead white fillers may be utilized as fillers for the polymer composition.

The particular white filler may be chosen from fillers such as, for example, a kaolinitic clay (e.g. kaolin or ball clay), a calcined kaolinitic clay, calcium carbonates, silicates of aluminum and calcium (e.g. the natural calcium silicate known as wollastonite), bauxite, talc, mica, alumina trihydrate, silica, carbonates and hydroxides of magnesium (e.g. natural hydrotalcite), dolomite (i.e. the natural double carbonate of calcium and magnesium), calcium sulphate (e.g. gypsum), titanium dioxide, zinc oxide, yttria, boron nitride, nano-scale fillers such as boron nitride nanotubes, boron nitride nanosheets, zinc oxide nanotubes, and mixtures of two or more thereof. The white fillers may be natural or synthetic and, in particular, both natural and synthetic forms of calcium carbonate, silicates of aluminum and calcium, silica, carbonates and hydroxides of magnesium, calcium sulphate and titanium dioxide are within the scope of this invention. Where the material is synthetic it may be precipitated (as with calcium carbonate, silica and titanium dioxide). The white fillers specified above are commonly regarded as white filler; the term “white” used in relation to “filler” does not mean, however, that the mineral necessarily has a pure white color, but that it is substantially free of any strong non-white hue. Many of the white fillers which may be employed in the present invention are crystalline.

In one embodiment, the white filler of the invention may be used alone or in association with a second reinforcing filler, for example a reinforcing white filler such as silica. Preferably a highly dispersible precipitated silica is used as the second reinforcing white filler, in particular when the invention is used for the manufacture of treads for tires having low rolling resistance. Non-limiting examples of such preferred highly dispersible silicas, include silica Perkasil KS 430 from Akzo, the silica BV 3380 from Degussa, the silicas Zeosil 1165 MP and 1115 MP from Rhone-Poulenc, the silica Hi-Sil 2000 from PPG, and the silicas Zeopol 8741 or 8745 from Huber.

In one embodiment, the white filler particles have an average particle size of about 100 microns or less, 50 microns or less, or 20 microns or less. In still another embodiment, the filler particles may have a particle size of less than 1 micron, and may be on the order of 1 to 900 nm. The specific surface area of the white fillers may be selected as desired. In one embodiment, the fillers may have a specific surface area of at least 0.01 m²g⁻¹, as measured by the BET nitrogen adsorption method and will preferably be no greater than about 300 m²g⁻¹. In one embodiment, the specific surface area will be in the range of from 0.1 to 100 m²g⁻¹; from 0.5 to 50 m²g⁻¹; from 1 to 25 m²g⁻¹; even from 2 to 10 m²g⁻¹. Here as elsewhere in the specification and claims, numerical values may be combined to form new or non-disclosed ranges. By way of example, kaolinitic clay and calcined kaolinitic clay each have a specific surface area of about 5-6 m²g⁻¹ whereas that for alumina trihydrate is about 30 m²g⁻¹. For certain ultrafine precipitated silicas the value might be as high as 200 m²g⁻¹ or more.

The filler may be present in an amount of 0.1 to 70% by weight of the polymer composition, or from 1 to 30% by weight, or from 1.5 to 10% by weight, or even 2 to 5% by weight of the polymer composition. In still another embodiment, the filler is present in an amount of about 3 to about 5% by weight of the polymer composition. Here as elsewhere in the specification and claims, numerical values may be combined to form new or non-disclosed ranges.

In one embodiment, the polymer composition comprises BN powders as a filler. BN is both electrically insulating and white and can therefore be readily used in a wide range of applications. Further, high aspect ratio crystalline platelets of BN are available as powders and can be incorporated into the resins easily. Theoretical calculations based on the Lewis Nielsen model show that adding merely 3-10 percent by weight of BN powders may approximately double the thermal conductivity of the plastic resin. Such a low loading leads to other benefits such as lower compounding costs, better physical properties, and/or full freedom in the color space. Another advantage of BN using powders for this application is they provide unique optical properties, and can enable an artificial frosted appearance in the final part.

In one embodiment, the polymer compositions in accordance with the present invention may be used as the material for forming the desired product or part by molding. In another embodiment, the mold itself may be formed from a polymer composition in accordance with the present invention. In one embodiment the mold is formed from a polymer composition comprising (1) a thermoset polymer, and (2) a thermally conductive filler. In one embodiment the polymer compositions comprises a born nitride filler.

The thermally conductive fillers operate to increase the thermal conductivity of the polymer composition. In one embodiment, the polymer compositions have a thermal conductivity of 0.2 to about 3 W/mK; from about 0.3 to about 1.5 W/mK; or from about 0.4 to about 1 W/mK. Here as elsewhere in the specification and claims, numerical values may be combined to form new and undisclosed ranges.

The present invention also provides a method of molding comprising (1) metering a polymer material into a mold defining a cavity having a selected shape, (2) holding the mold under pressure while the polymer material cools or crosslinks to thereby form a molded article, and (3) removing or ejecting the molded article from the mold where the polymer material metered into the mold, where polymer material, the mold itself, or both comprises a polymer composition comprising (a) a polymer material, and (b) a thermally conductive filler. The time required by the polymer composition to cool or crosslink in the mold is reduced as needed to heat to a uniform temperature as well as cool to temperature compared to a process employing a material substantially free of a thermally conductive filler. This reduces the molding cycle time and the overall injection molding time. The reduction in cycle time is beneficial as it reduces the cost of molding.

While the apparatus and method of subject invention have been shown and described with reference to preferred embodiments, those skilled in the art will readily appreciate that changes and/or modifications may be made thereto without departing from the spirit and scope of the subject invention.

What is claimed is:

1. A method for forming a molded article comprising:
(a) metering a polymer composition to a mold defining a cavity;
(b) holding the mold under pressure for a period of time and allowing the polymer composition to cool and/or cross-link to form a molded article; and
(c) removing the molded article from the mold, wherein the polymer composition comprises a (i) polymer material, and a (ii) a thermally conductive filler.

2. The method of claim 1, wherein the polymer composition comprises the thermally conductive filler in an amount of from about 0.1 percent by weight to about 70 percent by weight of the polymer composition.

3. The method of claim 1, wherein the polymer composition comprises the thermally conductive filler in an amount of from about 1 percent by weight to about 30 percent by weight of the polymer composition.

4. The method of claim 1, wherein the polymer composition comprises the thermally conductive filler in an amount of from about 1.5 percent by weight to about 10 percent by weight of the polymer composition.

5. The method of claim 1, wherein the polymer composition comprises the thermally conductive filler in an amount of from about 2 percent by weight to about 5 percent by weight of the polymer composition.

6. The method of any of claim 1, wherein the thermally conductive filler is chosen from a metal oxide, a metal boride, a metal carbide, a metal nitride, a metal silicide, carbon black, graphite, expanded graphite, carbon fiber, metallic powder, nano-scale fiber, or graphite fiber or a combination of two or more thereof.

7. The method of any of claim 1, wherein the thermally conductive filler is chosen from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, and mixtures of two or more thereof.

8. The method of any of claim 1, wherein the thermally conductive filler is a white filler.

9. The method of claim 8, wherein the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, alumina, magnesia, boron nitride nanotubes, boron nitride nanosheets, zinc oxide nanotubes, and mixtures of two or more thereof.

10. The method of claim 9, wherein the white filler has a specific surface area of 0.01 m²g⁻¹ to 300 m²g⁻¹.

11. The method of claim 9, wherein the white filler has a specific surface area of 0.1 m²g⁻¹ to 100 m²g⁻¹.

12. The method of claim 1, wherein the thermally conductive filler comprises boron nitride.

13. The method of claim 12, wherein the polymer composition comprises boron nitride in an amount of from about 3 percent by weight to about 10 percent by weight of the polymer composition.

14. The method of any of claim 1, wherein the polymer material is chosen from a thermoplastic or thermoset material.

15. The method of any of claim 1, wherein the polymer material is chosen from polycarbonate, a polyolefin, an acrylic, a vinyl, a fluorocarbon, a polyamide, a polyester, a polyphenylene sulfide, a liquid crystal polymer, an epoxy, a polyimide, a polyester, an acrylonitrile, or a combination of two or more thereof.

16. The method of any of claim 1, wherein the mold is formed from a polymer composition comprising (iii) a polymer material, and (iv) a thermally conductive filler.

17. The method of claim 16, wherein the polymer material (iii) is a thermoset material.

18. The method of claim 16, wherein the thermally conductive material (iv) comprises boron nitride.

19. The method of any of claim 1, wherein the time for performing steps (a)-(c) is less than the time for performing such steps using a polymer composition that is devoid of the thermally conductive filler (ii).

20. A molded article formed by the method of any of claim 1.

21. A method for forming a molded article comprising:
(a) metering a polymer composition to a mold defining a cavity;
(b) holding the mold under pressure for a period of time and allowing the polymer composition to cool and/or cross-link to form a molded article; and
(c) removing the molded article from the mold, wherein the mold is formed from a polymer composition comprises a (i) polymer material, and a (ii) a thermally conductive filler.

22. The method of claim 21, wherein the polymer composition comprises the thermally conductive filler in an amount of from about 0.1 percent by weight to about 70 percent by weight of the polymer composition.

23. The method of claim 21, wherein the polymer composition comprises the thermally conductive filler in an amount of from about 1 percent by weight to about 30 percent by weight of the polymer composition.

24. The method of claim 21, wherein the polymer composition comprises the thermally conductive filler in an amount of from about 1.5 percent by weight to about 10 percent by weight of the polymer composition.

25. The method of claim 21, wherein the polymer composition comprises the thermally conductive filler in an amount of from about 2 percent by weight to about 5 percent by weight of the polymer composition.

26. The method of any of claim 21, wherein the thermally conductive filler is chosen from a metal oxide, a metal boride, a metal carbide, a metal nitride, a metal silicide, carbon black, graphite, expanded graphite, carbon fiber, metallic powder, nano-scale fiber, or graphite fiber or a combination of two or more thereof.

27. The method of claim 26, wherein the thermally conductive filler is chosen from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, and mixtures of two or more thereof.

28. The method of claim 26, wherein the thermally conductive filler is a white filler.

29. The method of claim 28, wherein the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, alumina, magnesia, boron nitride nanotubes, boron nitride nanosheets, zinc oxide nanotubes, and mixtures of two or more thereof.

30. The method of claim 29, wherein the white filler has a specific surface area of 0.01 m²g⁻¹ to 300 m²g⁻¹.

31. The method of claim 29, wherein the white filler has a specific surface area of 0.1 m²g⁻¹ to 100 m²g⁻¹.

32. The method of claim 21, wherein the thermally conductive filler comprises boron nitride.

33. The method of claim 32, wherein the polymer composition comprises boron nitride in an amount of from about 3 percent by weight to about 10 percent by weight of the polymer composition.

34. The method of any of claim 21, wherein the polymer material is chosen from a thermoplastic or thermoset material.

35. The method of any of claims 21-33, wherein the polymer material is chosen from polycarbonate, polyolefins, acrylics, vinyls, fluorocarbons, polyamides, polyesters, polyphenylene sulfide, and liquid crystal polymers, an epoxy, a polyimide, a polyester, an acrylonitrile, or a combination of two or more thereof.

36. A molded article formed by the method of any of claim 21.

37. A thermally conductive composition comprising:
a polymer material; and
a thermally conductive filler.

38. The composition of claim 37, wherein the polymer composition comprises the thermally conductive filler in an amount of from about 0.1 percent by weight to about 70 percent by weight of the polymer composition.

39. The composition of claim 37, wherein the polymer composition comprises the thermally conductive filler in an amount of from about 1 percent by weight to about 30 percent by weight of the polymer composition.

40. The composition of claim 37, wherein the polymer composition comprises the thermally conductive filler in an amount of from about 1.5 percent by weight to about 10 percent by weight of the polymer composition.

41. The composition of claim 37, wherein the polymer composition comprises the thermally conductive filler in an amount of from about 2 percent by weight to about 5 percent by weight of the polymer composition.

42. The method of any of claim 37, wherein the thermally conductive filler is chosen from a metal oxide, a metal boride, a metal carbide, a metal nitride, a metal silicide, carbon black, graphite, expanded graphite, carbon fiber, metallic powder, nano-scale fiber, or graphite fiber or a combination of two or more thereof.

43. The method of any of claim 37, wherein the thermally conductive filler is chosen from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, and mixtures of two or more thereof.

44. The composition of any of claim 37, wherein the thermally conductive filler is a white filler.

45. The composition of claim 44, wherein the white filler is chosen from a kaolinitic clay, a calcined kaolinitic clay, a calcium carbonate, a silicate of aluminum, a silicate of calcium, bauxite, talc, mica, alumina trihydrate, silica, a carbonate of magnesium, a hydroxide of magnesium, dolomite, calcium sulphate, titanium dioxide, zinc oxide, yttria, boron nitride, alumina, magnesia, nano-scale fillers such as boron nitride nanotubes, boron nitride nanosheets, zinc oxide nanotubes, and mixtures of two or more thereof.

46. The composition of claim 45, wherein the white filler has a specific surface area of 0.01 m²g⁻¹ to 300 m²g⁻¹.

47. The composition of claim 45, wherein the white filler has a specific surface area of 0.1 m²g⁻¹ to 100 m²g⁻¹.

48. The composition of claim 37, wherein the thermally conductive filler comprises boron nitride.

49. The composition of claim 48, wherein the polymer composition comprises boron nitride in an amount of from about 3 percent by weight to about 10 percent by weight of the polymer composition.

50. The composition of any of claim 37, wherein the polymer material is chosen from a thermoplastic or thermoset material.

51. The composition of any of claim 37, wherein the polymer material is chosen from polycarbonate, a polyolefin, an acrylic, a vinyl, a fluorocarbon, a polyamide, a polyester, a polyphenylene sulfide, a liquid crystal polymer, an epoxy, a polyimide, a polyester, an acrylonitrile, or a combination of two or more thereof.
